(19) United States
(12) Patent Application Publication
(10) Pub. No.: US 2013/0174206 A1
(43) Pub. Date: Jul. 4, 2013

(54) VCR CONTROL CAPABILITIES FOR INFORMATION PLAY SESSIONS

(71) Applicants: Jayakumar Balaji, Chennai (IN); Balasubramanian Gopalasubramanian, Chennai (IN); Sugumaran Prasanna Kumar, Chennai (IN); Muthukaruppan Rajesh Krishnan, Chromepet (IN); Syed Sulaiman, Nanganallur (IN)

(72) Inventors: Jayakumar Balaji, Chennai (IN); Balasubramanian Gopalasubramanian, Chennai (IN); Sugumaran Prasanna Kumar, Chennai (IN); Muthukaruppan Rajesh Krishnan, Chromepet (IN); Syed Sulaiman, Nanganallur (IN)

(21) Appl. No.: 13/701,878

(22) PCT Filed: Sep. 10, 2010
(86) PCT No.: PCT/EP10/63289

§ 371 Date: Mar. 13, 2013

(30) Foreign Application Priority Data
Jul. 2, 2010 (IN) 1886/CHE/2010

(51) Int. Cl. H04N 21/643; H04N 21/2387

(52) U.S. Cl. CPC H04N 21/64322; H04N 21/2387
USPC 725/88; 725/109

(57) ABSTRACT

The present invention relates to IMS networks and, more particularly, to information recording sessions in IMS networks. System and method for enabling control options while information is being recorded from a user. A Media Gateway Controller sends the control options to a Media Server. The Media Server receives a control command from the user, wherein the control command is based on the control options and the Media Server performs an action on the information based on the control command. The user is an Internet Protocol Multimedia Subsystem (IMS) user. The Media Gateway Controller sends the control options to the Media Server in a Session Initiation Protocol (SIP) INFO message using Media Server Markup Language (MSML) format.

### TECHNICAL FIELD

The present invention relates to IMS networks and, more particularly, to information recording sessions in IMS networks.

### BACKGROUND

Users in a communication network may communicate some information to the network. The information may be in the form of an audio message. The network may receive the information, record and store the information. In Internet Protocol Multimedia Subsystem (IMS) networks, the only control options available to the user are to start the recording session for the information and to end/terminate the recording session.

Apart from the two available control options, the user may need to exercise greater control over the information that is being recorded by the network. For example, if the user is saying a message to the network, and the user makes a mistake while saying the message, then the network would record the wrong message and the user does not have an option to correct the mistake without re-starting the communication session with the network.

### SUMMARY

In view of the foregoing, an embodiment herein provides a method for enabling control options while information is being recorded from a user. A Media Gateway Controller sends the control options to a Media Server. The Media Server receives a control command from the user, wherein the control command is based on the control options and the Media Server performs an action on the information based on the control command. The user is an Internet Protocol Multimedia Subsystem (IMS) user. The Media Gateway Controller sends the control options to the Media Server in a Session Initiation Protocol (SIP) INFO message using Media Server Markup Language (MSML) format. The control options are at least one of cancel recording, restart recording, replay recorded information, delete recorded file and message deletion timeout after specified time duration.

Embodiments further disclose a Media Gateway Controller for enabling control options while information is being recorded from a user. The Media Gateway Controller receives the control options from a Service Control Point, maps the control options to a message that can be sent to a Media Server and sends the control options to a Media Server. The Media Gateway Controller maps the control options to a Session Initiation Protocol (SIP) INFO message using Media Server Markup Language (MSML) format. The user is an Internet Protocol Multimedia Subsystem (IMS) user.

Embodiments herein also disclose a Media Server for enabling control options while information is being recorded from a user. The Media Server receives a control command from the user and performs an action on the information based on the control command. The user is an Internet Protocol Multimedia Subsystem (IMS) user. The Media Server receives the control options from a Media Gateway Controller.

Also, disclosed herein is a system for enabling control options while information is being recorded from a user. The system receives a control command from the user and performs an action on the information based on the control command. The user is an Internet Protocol Multimedia Subsystem (IMS) user. The control options are at least one of cancel recording, restart recording, replay recorded information, delete recorded file and delete recorded information after specified time duration.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of users in an IMS network, according to an embodiment herein;

FIG. 2 is a block diagram of a Media Gateway Controller (MGC), according to an embodiment herein;

FIG. 3 is a block diagram of a Media Server (MS), according to an embodiment herein;

FIGS. 4a and 4b are flowcharts depicting a method for enabling control options when information is being recorded by the network, according to an embodiment herein;

FIG. 5 illustrates a flow diagram for an example illustrating use of a control option when information is being recorded by the network, according to an embodiment herein; and

FIG. 6 illustrates a flow diagram for an example illustrating use of a control option when information is being recorded by the network, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

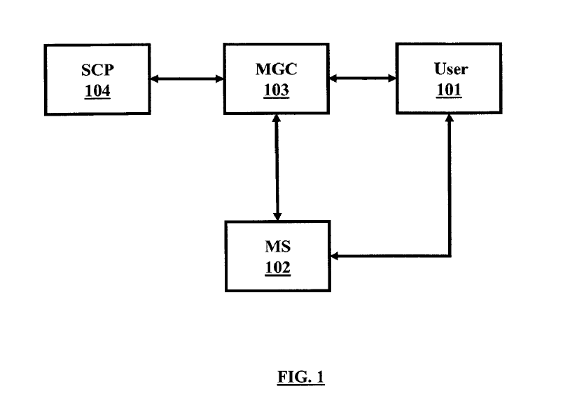

The embodiments herein disclose system and method for enabling control options while information is being recorded from a user. Referring now to the drawings, and more particularly to FIGS. 1 through 6, where similar reference characters denote corresponding features consistently throughout the figures, there are shown embodiments.

FIG. 1 illustrates a block diagram of users in an IMS network. A user 101 in an IMS network may communicate some information to the network. The network receives the information, records and stores the information. If the message is to be delivered to a destination user, then the network sends the message to the destination user. The information communicated by the user 101 would be received by a Media Server (MS) 102. The user 101 may communicate information to the MS 102 using a communication terminal and the user may use Session Initiation Protocol (SIP) for communication with the network. The MS 102 records and stores the received information. The MS 102 is a server that helps establish and maintain a multi media session with the user 101. The MS 102 also stores media and shares the stored media with users of the network. Before communicating the information, the user 101 initiates a communication link with the network. The user 101 may initiate the communication link by sending a request to a Media Gateway Controller (MGC) 103. The MGC 103 receives signaling information from the MS 102 and instructs the MS 102 to receive information from the user 101. The MGC 103 also acts as a Service Switching Point (SSP) and makes available additional services during a communication session. In other embodiments, the SSP may be a network element located outside the MGC 103.

On receiving the request from the user 101 and on determining that information has to be recorded from the user 101, the MGC 103 triggers a Service Control Point (SCP) 104. The SCP 104 is used to help control the services offered by the network. The SCP 104 identifies the number to which a communication session is to be routed and then routes the communication session to the number. The SCP 104 also helps in playing voice messages or prompt announcements to the IN user 101. The SCP 104 contains the service logic that implements the services related to receiving information from the user 101. On being triggered, the SCP 104 instructs the MS 102, using the MGC 103, to establish a communication link with the user 101. When information has to be recorded from the user 101, the SCP 104 sends a prompt announcement to the MS 102 and instructs the MS 102 that information has to be recorded from user 101. If an announcement has to be made to the user 101 before recording the information, then the SCP 104 also sends an announcement ID indicating the announcement to be played to user 101 before recording the information. For example, the SCP 104 may send a Prompt and Receive Message (PARM) to the MS 102. A PARM is used to play a prompt announcement and record information from the user 101 and includes the announcement ID of the announcement to be played to the user 101. The prompt announcement played to the user 101 may be “Enter the message”. After the announcement is played to the user 101, the user 101 can communicate the information to the MS 102 and the MS 102 records the received information. The PARM also includes recorded information ID. The ID of the recorded information indicates the location in the MS 102 where the recorded information is to be stored. The PARM may also include control options that can be exercised by the user 101 while the information is being recorded by the MS 102. For example, the control options may be:

Cancel recording: to cancel the ongoing recording session. The information already recorded would be deleted from the MS 102.
Restart recording: all the information recorded so far would be deleted from the MS 102 and a new recording session would be started.
Replay recorded information: the ongoing recording session would be terminated and the recorded message would be played to the user 101.
Delete recorded file: the information recorded from the user 101 would be deleted.
Message deletion timeout: is the maximum time period for which information would be stored in the MS 102.
The SCP 104 sends the message to the MS 102 through the MGC 103. On receiving the message, the MGC 103 maps the message to a message that may be interpreted by the MS 102. The MGC 103 also maps the prompt announcement ID to the corresponding Uniform Resource Locator (URL) of the prompt announcement and the recorded information ID to the URL of the storage location of the recorded announcement. The URL of the prompt announcement indicates the location of the prompt announcement in the MS 102. The MGC 103 then sends the message to the MS 102.

On receiving the message from the MGC 103, the MS 102 determines that information has to be recorded from the user 101. The MS 102 locates the prompt announcement using the URL of the prompt announcement and plays the prompt announcement to the user 101. The MS 102 may also convey the control options to the user 101 before recording the information communicated by the user 101. For example, the MS 102 may inform the user 101 that the control option to cancel the information is #3, which can be entered using a communication terminal. The MS 102 stores the recorded information in the location indicated by the URL of the storage location. If the user 101 wants to cancel the information, then the user 101 enters #3 using the communication terminal. The controls options may be conveyed to the user 101 when the user 101 subscribes to the communication network or the controls options may be conveyed to the user 101 during each communication session through a prompt announcement. The control options may be any single key or a combination of multiple keys on the communication terminal and the control options may be sent from the communication to the MS 102 using Dual Tone Multi Frequency (DTMF) signaling. Information transfer between the MS 102 and the user 101 may happen through Real-time Transport Protocol (RTP). If the user 101 exercises any control option during the recording session, then the MS 102 receives the control command and performs an action on the recorded information according to the control command.

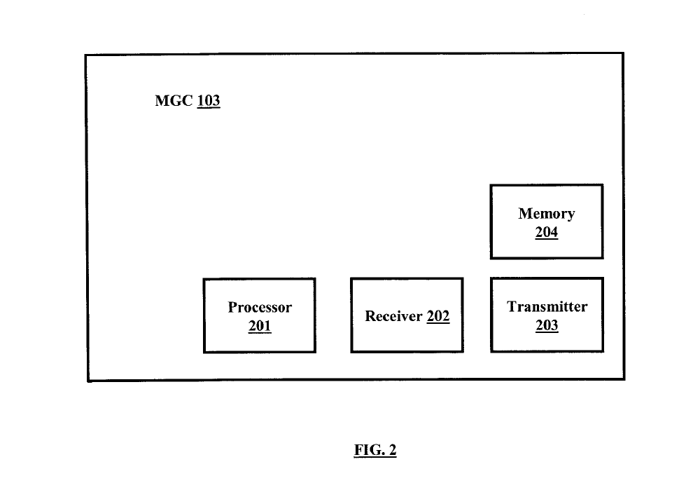

FIG. 2 is a block diagram of a Media Gateway Controller (MGC). A user 101 in an IMS network may communicate some information to the network. The network receives the information, records and stores the information. Before communicating the information, the user 101 initiates a communication link with the network. The user 101 may initiate the communication link by sending a request to the MGC 103. The MGC 103 receives the request through a receiver 202. On receiving the request from the user 101 and on determining that information has to be recorded from the user 101, the MGC 103 triggers the SCP 104. On being triggered, the SCP 104 instructs the MS 102, using the MGC 103, to establish a communication link with the user 101. When information has to be recorded from the user 101, the SCP 104 sends a prompt announcement to the MS 102 and instructs the MS 102 that information has to be recorded from user 101. If an announcement has to be made to the user 101 before recording the information, then the SCP 104 also sends an announcement ID indicating the announcement to be played to user 101 before recording the information. The SCP 104 sends the message to the MS 102 through the MGC 103. On receiving the message, the MGC 103 maps the message to a message that can be interpreted by the MS 102. For example, the MGC 103 may map the message to a Session Initiation Protocol (SIP) INFO message using Media Server Markup Language (MSML) format. The MGC 103 also maps the prompt announcement ID to the corresponding URL of the prompt announcement and the recorded information ID to the URL of the storage location of the recorded announcement. For example, if the prompt announcement ID indicates that the prompt announcement to be played to the user 101 is “Enter the message” and the prompt announcement is located at “loc1” in the MS 102 and the name of the prompt announcement file is “VB1.wav” then the URL of the prompt announcement may be “file:/loc1/VB1.wav”. If the recorded information ID indicates that the recorded information is to be stored in location “loc2” under the name Rec1 then the URL of the storage location may be “file:/loc2/Rec1.wav”. A processor 201 controls the functioning of the MGC 103. All the actions performed by the MGC 103 are coordinated by the processor 201. The processor 201 maps the message and the announcement ID received from the SCP 104 to the URL of the announcement. The URL of a corresponding announcement ID may be stored in a memory 204. The MGC 103 then sends the message to the MS 102. The MGC 103 sends the URL of the announcement to the MS 102 through a transmitter 203. On receiving the message from the MGC 103, the MS 102 determines that information has to be recorded from the user 101. The MS 102 locates the prompt announcement using the URL of the prompt announcement and plays the prompt announcement to the user 101. The MS 102 may also convey the control options to the user 101 before recording the information communicated by the user 101. When the user 101 communicates the information, the MS 102 receives the information, records and stores the information. The MS 102 stores the recorded information in the location indicated by the URL of the storage location. For example, the recorded information may be stored at location “loc2” under the name Rec1. If the user 101 exercises any control option during the recording session, then the MS 102 receives the control command and performs an action on the recorded information according to the control command.

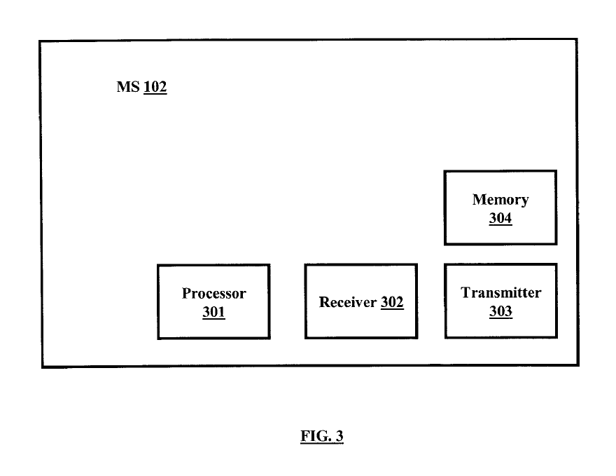

FIG. 3 is a block diagram of a Media Server (MS). A user 101 in an IMS network may communicate some information to the network. The network receives the information, records and stores the information. Before communicating the information, the user 101 initiates a communication link with the network. The user 101 may initiate the communication link by sending a request to the MGC 103. On receiving the request from the user 101 and on determining that information has to be recorded from the user 101, the MGC 103 triggers the SCP 104. On being triggered, the SCP 104 instructs the MS 102, using the MGC 103, to establish a communication link with the user 101. When information has to be recorded from the user 101, the SCP 104 sends a prompt announcement to the MS 102 and instructs the MS 102 that information may have to be recorded from the user 101. If an announcement has to be made to the user 101 before recording the information, then the SCP 104 also sends an announcement ID indicating the announcement to be played to user 101 before recording the information. The SCP 104 sends the message to the MS 102 through the MGC 103. On receiving the message, the MGC 103 maps the message to a message that can be interpreted by the MS 102. The MGC 103 also maps the prompt announcement ID to the corresponding URL of the prompt announcement and the recorded information ID to the URL of the storage location of the recorded announcement. The MGC 103 then sends the message to the MS 102. The MS 102 receives the message from the MGC 103 through a receiver 302. On receiving the message from the MGC 103, the MS 102 determines that information has to be recorded from the user 101. A processor 301 controls the functioning of the MS 102. All the actions performed by the MS 102 are co-ordinated by the processor 301. The processor 301 locates the prompt announcement from a memory 304 using the URL of the prompt announcement and plays the prompt announcement to the user 101. For example, if the URL of the prompt announcement received from the MGC 103 is “file:/loc1/PROMPT1.wav” and the location indicated by the URL has the prompt announcement “Enter the information” then the MS 102 plays the announcement to user 101. The MS 102 sends the announcement to the user 101 through a transmitter 303. The MS 102 may also convey the control options to the user 101 before recording the information communicated by the user 101. When the user 101 communicates information to the MS 102, the MS 102 receives the information, records and stores the information. The MS 102 receives the information from the user 101 through the receiver 302 and stores the recorded information in the memory 304. The processor 301 stores the recorded information in the location indicated by the URL of the memory 304. If the user 101 exercises any control option during the recording session, then the MS 102 receives the control command and the processor 301 performs an action on the recorded information according to the control command.

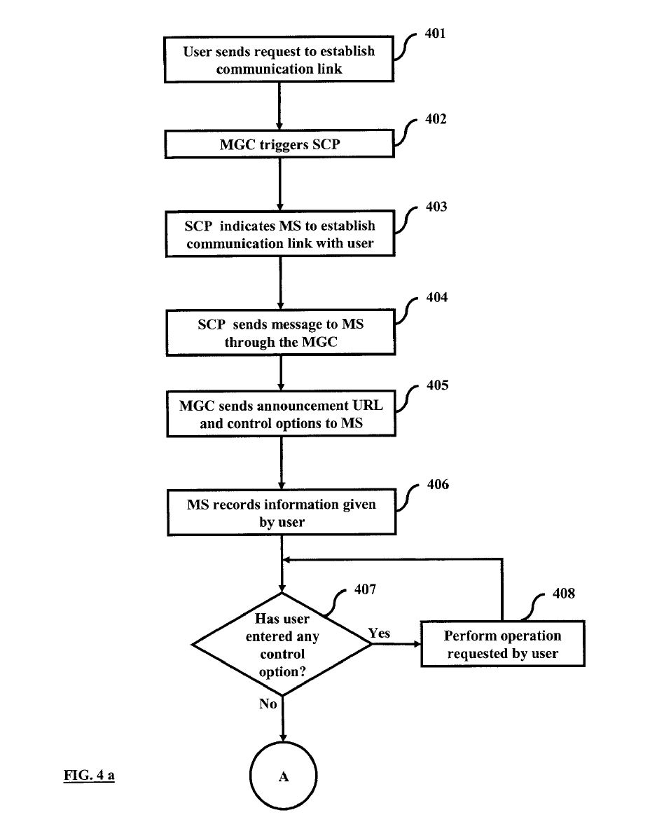

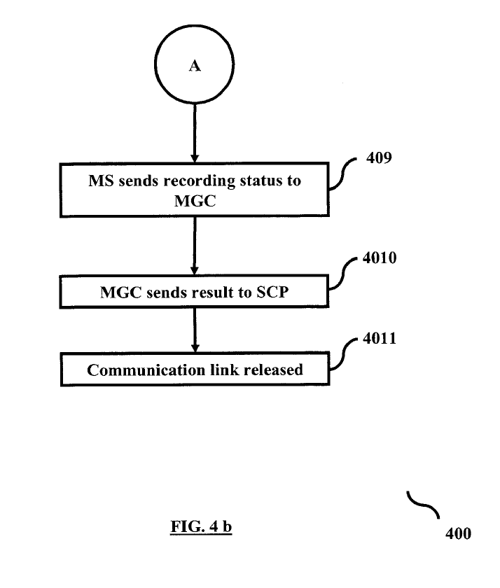

FIGS. 4a and 4b are flowcharts depicting a method for enabling control options when information is being recorded by the network. A user 101 in an IMS network may communicate some information to the network. The network receives the information, records and stores the information. Before communicating the information, the user 101 initiates (401) a communication link with the network. The user 101 may initiate the communication link by sending a request to the MGC 103. On receiving the request from the user 101 and on determining that information has to be recorded from the user 101, the MGC 103 triggers (402) the SCP 104. On being triggered, the SCP 104 instructs (403) the MS 102, using the MGC 103, to establish a communication link with the user 101. When information has to be recorded from the user 101, the SCP 104 sends a prompt announcement to the MS 102 and instructs the MS 102 that information may have to be recorded from the user 101. If an announcement has to be made to the user 101 before recording the information, the SCP 104 may also send an announcement ID indicating the announcement to be played to user 101 before recording the information. The SCP 104 then sends (404) the message to the MS 102 through the MGC 103. On receiving the message, the MGC 103 maps (405) the message to a message that can be interpreted by the MS 102. The MGC 103 also maps the prompt announcement ID to the corresponding URL of the prompt announcement and the recorded information ID to the URL of the storage location of the recorded announcement. The MGC 103 then sends (406) the message to the MS 102. On receiving the message from the MGC 103, the MS 102 determines that information has to be recorded from the user 101. The MS 102 plays the prompt announcement to the user 101 and records (407) the information communicated by the user 101. If the user 101 exercises (408) any control option during the recording session, then the MS 102 receives the control command and performs (409) an action on the recorded information according to the control command. After the recording session is complete, the MS 102 sends (4010) the status of the recording session to the MGC 103. For example, if the session is complete, then the MS 102 may send the status of the session as “Complete”, to the MGC 103. The MGC 103 sends (4011) the status of the session, to the SCP 104. Once the recording session is complete, the communication link with the user 101 may be released (4012). The various actions in method 400 may be performed in the order presented, in a different order or simultaneously. Further, in some embodiments, some actions listed in FIG. 4 may be omitted.

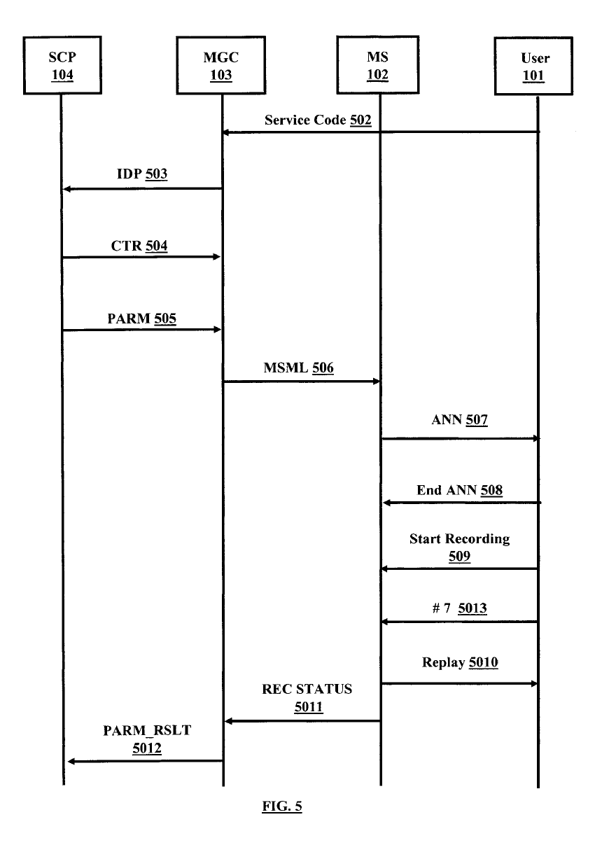

FIG. 5 illustrates a flow diagram for an example illustrating use of a control option when information is being recorded by the network. A user 101 in an IMS network may communicate some information to the network. The network receives the information, records and stores the information. Before communicating the information, the user 101 initiates a communication link with the network. The user 101 may initiate the communication link by sending a request to the MGC 103. If the user 101 wants to avail of any specific service offered by the network, then the user 101 also sends the Service code 502 of the service along with the request. On receiving the request from the user 101, and on determining that information may be transferred between the user 101 and the network, the MGC 103 triggers the SCP 104. The MGC 103 may trigger the SCP 104 by sending an Initial Detection Point (IDP) 503 to the SCP 104. On being triggered, the SCP 104 instructs the MS 102, using the MGC 103, to start a communication session with the user 101. The SCP 104 sends a message to the MS 102, through the MGC 103, to instruct the MS 102. The SCP 104 may send a Connect to Resource (CTR) 504 message to the MGC 103 and the MGC 103 may send an invitation message to the MS 102. The MS 102 then establishes a communication session with the user 101.

From the request message and the service code number entered by the user 101, the SCP 104 determines that information would have to be received and recorded from the user 101. The SCP 104 sends a PARM 505 to the MGC 103 in order to play a prompt announcement to the user 101 and receive information from the user 101. The SCP 104 sends an announcement ID, recorded information ID and the control options in the PARM 505. On receiving the prompt announcement ID from the SCP 104, the MGC 103 maps the prompt announcement ID to the corresponding URL of the announcement and the recorded information ID to the URL of the storage location of the recorded announcement and sends the URL's to the MS 102. The MGC 103 may send the URL's as a SIP info message in MSML 506 format. The MGC 103 also informs the MS 102 that information may have to be received from the user 101 and that the user 101 can exercise control options while the information is being recorded. The MGC 103 also maps the control options received from the SCP 104 and sends the control options to the MS 102 in the MSML 506 message. On receiving the message from the MGC 103, the MS 102 locates the announcement using the URL of the announcement and plays the announcement to the user 101. The announcement may be played as an ANN 507 message and the announcement may be played to the user 101 through a Real-time Transport Protocol (RTP) connection between the user 101 and the MS 102. After the announcement is complete, indicated as End ANN 508, the user 101 can start communicating information to the MS 102. When the user 101 is communicating the information, the MS 102 can Start Recording 509 the information. While the MS 102 records the information, if the user 101 wishes to replay the information that has already been recorded, then the user 101 can exercise the control option for replaying the information. The user 101 may enter “#7” 5013 on a communication terminal to replay the recorded information. When the MS 102 receives the command to replay the recorded information, the MS 102 stops the ongoing recording session and replays the recorded information, as Replay 5010, to the user 101. After the MS 102 has completed replaying the information, the MS 102 sends the status of the recording session to the MGC 103. The MS 102 may send the status of the recording as a REC STATUS 5011 message. The MGC 103 then sends the status of the PARM session to the SCP 104. The MGC 103 may send the status as a PARM_RSLT 5012.

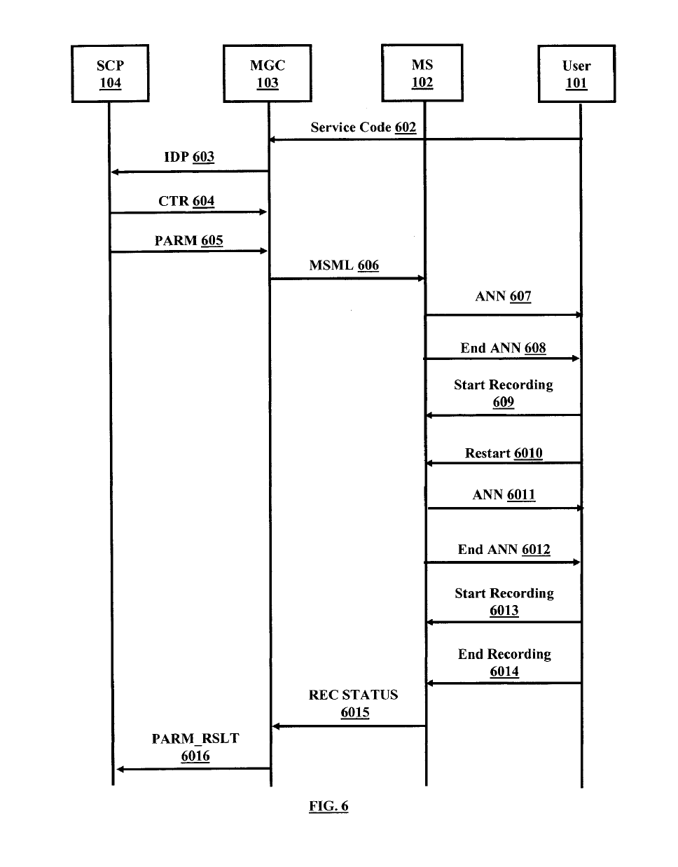

FIG. 6 illustrates a flow diagram for an example illustrating use of a control option when information is being recorded by the network. A user 101 in an IMS network may communicate some information to the network. The network receives the information, records and stores the information. Before communicating the information, the user 101 initiates a communication link with the network. The user 101 may initiate the communication link by sending a request to the MGC 103. If the user 101 wants to avail of any specific service offered by the network, then the user 101 also sends the Service code 602 of the service along with the request. On receiving the request from the user 101, and on determining that information may be transferred between the user 101 and the network, the MGC 103 triggers the SCP 104. The MGC 103 may trigger the SCP 104 by sending an Initial Detection Point (IDP) 603 to the SCP 104. On being triggered, the SCP 104 instructs the MS 102, using the MGC 103, to start a communication session with the user 101. The SCP 104 sends a message to the MS 102, through the MGC 103, to instruct the MS 102. The SCP 104 may send a Connect to Resource (CTR) 604 message to the MGC 103 and the MGC 103 may send an invitation message to the MS 102. The MS 102 then establishes a communication session with the user 101.

From the request message and the service code number entered by the user 101, the SCP 104 determines that information would have to be received and recorded from the user 101. The SCP 104 sends a PARM 605 to the MGC 103 in order to play a prompt announcement to the user 101 and receive information from the user 101. The SCP 104 sends an announcement ID, recorded information ID and the control options in the PARM 605. On receiving the prompt announcement ID from the SCP 104, the MGC 103 maps the prompt announcement ID to the corresponding URL of the announcement and the recorded information ID to the URL of the storage location of the recorded announcement and sends the URL's to the MS 102. The MGC 103 may send the URL's as a SIP info message in MSML 606 format. The MGC 103 also informs the MS 102 that information may have to be received from the user 101 and that the user 101 can exercise control options while the information is being recorded. The MGC 103 also maps the control options received from the SCP 104 and sends the control options to the MS 102 in the MSML 606 message. On receiving the message from the MGC 103, the MS 102 locates the announcement using the URL of the announcement and plays the announcement to the user 101. The announcement may be played as an ANN 607 message and the announcement may be played to the user 101 through a Real-time Transport Protocol (RTP) connection between the user 101 and the MS 102. After the announcement is complete, indicated as End ANN 608, the user 101 can start communicating information to the MS 102. When the user 101 is communicating the information, the MS 102 can Start Recording 609 the information. While the MS 102 records the information, if the user 101 wishes to restart the recording session, then the user 101 can exercise the control option for restarting the session, shown as Restart 6010. The user 101 may enter “#7” on a communication terminal to restart the recording session. When the MS 102 receives the command to restart the session, the MS 102 stops the ongoing recording session, deletes the information that has been recorded so far and starts the recording session from the beginning. The MS 102 plays the prompt announcement, as ANN 6011, and when the announcement is complete, End ANN 6012 the MS 102 starts recording any information communicated by the user 101 as Start Recording 6013. After the MS 102 has completed replaying the information, shown as End Recording 6014, the MS 102 sends the status of the recording session to the MGC 103. The MS 102 may send the status of the recording as a REC STATUS 6015 message. The MGC 103 then sends the status of the PARM session to the SCP 104. The MGC 103 may send the status as a PARM_RSLT 6016.

The embodiments disclosed herein can be implemented through at least one software program running on at least one hardware device and performing network management functions to control the network elements. The network elements shown in FIG. 1, FIG. 2 and FIG. 3 include blocks which can be at least one of a hardware device, or a combination of hardware device and software module.

The embodiment disclosed herein specifies a system and method for enabling control options while information is being recorded from a user. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a code written in e.g. Very high speed integrated circuit Hardware Description Language (VHDL) any other coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for enabling control options for information recorded from a user in an Internet Protocol Multimedia Subsystem (IMS) network, said network comprising of a Media Gateway Controller (103) and a Media Server (102), the method comprising steps of:
said Media Gateway Controller (103) sending said control options to said Media Server (102);
said Media Server (102) receiving a control command from said user, wherein
said control command is based on said control options; and
said Media Server (102) performing an action on said information based on said control command.

2. The method, as claimed in claim 1, wherein said Media Gateway Controller (103) sends said control options to said Media Server (102) in a Session Initiation Protocol (SIP) INFO message using Media Server Markup Language (MSML) format.

3. The method, as claimed in claim 1, wherein said control options are at least one of:
cancel recording;
restart recording;
replay recorded information;
delete recorded file; and
message deletion timeout.

4. A Media Gateway Controller (103) for enabling control options for information recorded from a user in an Internet Protocol Multimedia Subsystem (IMS) network, said network further comprising of a Media Server (102), said Media Gateway Controller (103) having at least one means adapted for:
receiving said control options from a Service Control Point (104);
mapping said control options to a message that can be sent to said Media Server (102)
sending said control options to said Media Server (102)

5. The Media Gateway Controller (103), as claimed in claim 4, wherein said Media Gateway Controller (103) is adapted to map said control options to a Session Initiation Protocol (SIP) INFO message using Media Server Markup Language (MSML) format.

6. A Media Server (102) for enabling control options for information recorded from a user in Internet Protocol Multimedia Subsystem (IMS) network, said Media Server (102) having at least one means adapted for:
receiving a control command from said user; and
performing an action on said information based on said control command.

7. The Media Server (102), as claimed in claim 6, wherein said Media Server (102) is adapted to receive said control options from a Media Gateway Controller (103).

8. The Media Server (102), as claimed in claim 6, wherein said Media Server (102) is adapted to receive said control options, wherein said control options are at least one of:
cancel recording;
restart recording;
replay recorded information;
delete recorded file; and
delete recorded information after specified time duration.

9. A system for enabling control options for information recorded from a user in an Internet Protocol Multimedia Subsystem (IMS) network, said network comprising of a Media Gateway Controller (103) and a Media Server (102), said system adapted to perform steps of
said Media Gateway Controller (103) sending said control options to said Media Server (102);
said Media Server (102) receiving a control command from said user, wherein said control command is based on said control options; and
said Media Server (102) performing an action on said information based on said control command.

10. The system, as claimed in claim 1, wherein said Media Gateway Controller (103) is adapted to send said control options to said Media Server (102) in a Session Initiation Protocol (SIP) INFO message using Media Server Markup Language (MSML) format.

11. The system, as claimed in claim 1, wherein said Media Server (102) is adapted to receive said control options and said control options are at least one of:
cancel recording;
restart recording;
replay recorded information;
delete recorded file; and
message deletion timeout.
